(19) United States
(12) Patent Application Publication
(10) Pub. No.: US 2008/0168091 A1
(43) Pub. Date: Jul. 10, 2008

(54) System and Method of Ranking Tabular Data

(75) Inventors: Paul K. Young, Ithaca, NY (US); David Quinn-Jacobs, Ithaca, NY (US)

Correspondence Address: TECHNOLOGY, PATENTS AND LICENSING, INC., 2003 South EASTON ROAD, SUITE 208, DOYLESTOWN, PA, 18901, US

(73) Assignee: Graphwise, LLC

(21) Appl. No.: 11/621,784

(22) Filed: Jan. 10, 2007

(51) Int. Cl. G06F 17/30

(52) U.S. Cl. 707/104.1; 707/E17.002

(57) ABSTRACT

A method for ranking the quality of a set of tabular data includes determining one or more quality metrics corresponding to a set of tabular data. The quality metrics are combined to form a quality score for the set of tabular data.

### CROSS REFERENCE TO RELATED APPLICATIONS

This application is related to the following co-pending applications, each of which is incorporated by reference in this application:

U.S. patent application Ser. No. 11/401,673, entitled “Search Engine for Presenting to a User a Display having both Graphed Search Results and Selected Advertisements” (Attorney Docket No. GRA-001-US) filed on Apr. 10, 2006.

U.S. patent application Ser. No. 11/401,677, entitled “A System and Method for Creating a Dynamic Database for use in Graphical Representations of Tabular Data” (Attorney Docket No. GRA-002-US) filed on Apr. 10, 2006.

U.S. patent application Ser. No. 11/401,657, entitled “A System and Method for Presenting to a User a Preferred Graphical Representation of Tabular Data” (Attorney Docket No. GRA-003-US) filed on Apr. 10, 2006.

U.S. patent application Ser. No. 11/401,678, entitled “Search Engine for Evaluating Queries from a User and Presenting to the User Graphed Search Results” (Attorney Docket No. GRA-004-US) filed on Apr. 10, 2006.

U.S. patent application Ser. No. 11/401,812, entitled “Search Engine for Presenting to a User a Display having Graphed Search Results Presented as Thumbnail Presentation” (Attorney Docket No. GRA-005-US) filed on Apr. 10, 2006.

Further, this application is related to the following co-pending application:

U.S. patent application Ser. No. ______ entitled “System and Method for Locating and Extracting Tabular Data” (Attorney Docket No. GRA-006-US) filed on the same date herewith.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BRIEF DESCRIPTION OF THE DRAWINGS

The following detailed description will be better understood when read in conjunction with the appended drawings, in which there is shown one or more of the multiple embodiments of the present invention. It should be understood, however, that the various embodiments of the present invention are not limited to the precise arrangements and instrumentalities shown in the drawings.

In the Drawings:

FIG. 1 depicts an overall view of an embodiment of the present invention.

### DETAILED DESCRIPTION

The present invention determines quality metrics and a quality score for tabular data that is obtained from sources on a computer network or single computer. In one embodiment, the invention combines these determined metrics with subjective metrics to form a quality score, or rank index, for each particular set of tabular data. The rank indexes are stored by the system, and can be used by other systems. For example, the rank indexes can be examined by an Internet crawler application to help determine its next URL.

Certain terminology is used herein for convenience only and is not to be taken as a limitation on the embodiments of the present invention. In the drawings, the same reference letters are employed for designating the same elements throughout the several figures.

It is well known that data flow diagrams can be used to model and/or describe methods and systems and provide the basis for better understanding their functionality and internal operation as well as describing interfaces with external components, systems and people using standardized notation. When used herein, data flow diagrams are meant to serve as an aid in describing the embodiments of the present invention, but do not constrain implementation thereof to any particular hardware or software embodiments.

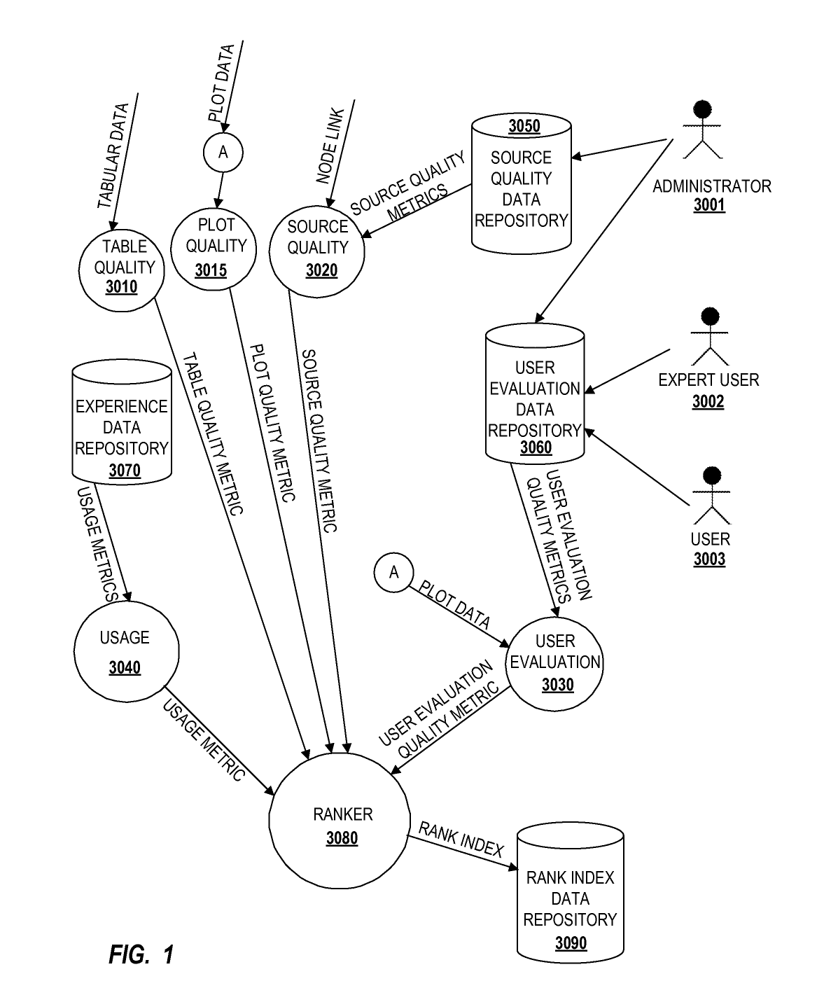

FIG. 1 illustrates an overview of the data and processes of an embodiment of the invention. The architecture of the depicted embodiment of the invention includes a number of interoperating software programs, potentially distributed across a varying number of computer servers. These software programs include: Table Quality 3010, Plot Quality 3015, Source Quality 3020, User Evaluation 3030, Usage 3040, Source Quality Data Repository 3050, User Evaluation Data Repository 3060 and Ranker 3080. In addition, the depicted embodiment includes a Rank Index Data Repository 3090, which, in alternate embodiments of the invention, may be a dedicated storage device, or may be shared with one or more other systems with which the depicted embodiment of the invention interoperates. Furthermore, the depicted embodiment includes an Experience Data Repository 3070 which is shared with one or more other systems with which the depicted embodiment of the invention interoperates.

Alternative embodiments of the invention comprise one or more of the above described software programs.

In the embodiment of the invention depicted in FIG. 1, five different software programs, Table Quality 3010, Plot Quality 3015, Source Quality 3020, User Evaluation 3030 and Usage 3040, determine metrics related to a network node and to the data received from that node. Each such metric can assume any value between and including 0 and 1. Each program provides its metric to the Ranker 3080, which then determines a quality score, or rank index, by combining the metrics.

Individual software programs of the embodiment of the invention depicted in FIG. 1 will now be discussed in greater detail.

### Table Quality 3010

Table Quality 3010 receives tabular data that has been obtained from a node of a computer network, and then determines a number of different submetrics related to the quality of that tabular data. In a further embodiment, Table Quality 3010 determines the submetrics by applying one or more rules to the tabular data. Each of these different submetrics is multiplied by a corresponding weighting factor, and the resulting products are summed to result in a table quality metric. Table Quality 3010 then provides this table quality metric to Ranker 3080. As used throughout this application, the phrase “a corresponding weighting factor” is meant to include situations in which each metric or submetric has its own individual weighting factor as well as situations in which one or more metrics or submetrics share a common weighting factor.

The submetrics determined by Table Quality 3010 comprise any combination of density, completeness of metadata, consistency and size metrics. The density submetric is based upon the extent to which the tabular data is populated with data values. By way of example, if tabular data that consists of 10 rows and 10 columns is missing three data values, then the density submetric might be calculated to have a value of 0.97, since 3 out of 100 data values are missing. The completeness of metadata submetric is determined by applying a rule that is based on metadata corresponding to the tabular data; the completeness of metadata submetric decreases to the extent that metadata is missing. Metadata corresponding to the tabular data includes row and column headings, the types of data, units of measurement and unit multipliers. For example, if the tabular data contains dollar values, but the metadata does not identify the year corresponding to the dollar values (e.g., “1980 dollars”), then the completeness of metadata submetric would be lower due to the missing “dollar year” metadata. The consistency submetric is based upon the extent to which neighboring data values differ from each other, i.e., the value of the consistency submetric varies with the continuity of the data. The size submetric is simply based upon the number of data values in the tabular data, i.e., the value of the size submetric varies with the size of the data.

### Plot Quality 3015

Plot Quality 3015 receives plot data, i.e., a view of tabular data that may be presented graphically, and then determines a number of different submetrics related to the quality of that plot data. In a further embodiment, Plot Quality 3015 determines the submetrics by applying a set of rules to the plot data. Each of these different submetrics is multiplied by a corresponding weighting factor, and the resulting products are summed to result in a plot quality metric. Plot Quality 3015 then provides this plot quality metric to Ranker 3080.

The submetrics determined by Plot Quality 3015 comprise any combination of density, completeness of metadata, consistency and size submetrics, which are described previously in the discussion regarding Table Quality 3010.

### Source Quality 3020

An individual, acting as an Administrator 3001 of the system, may generate submetrics, by subjective evaluation, of the quality of various network nodes. These submetrics, which are related to the quality of the network nodes as sources of tabular data, are received and stored by the Source Quality Data Repository 3050. When Source Quality 3020 receives a node link that identifies a particular network node, it retrieves any available submetrics corresponding to that node link from the Source Quality Data Repository 3050. Source Quality 3020 multiplies each of these different submetrics by a corresponding weighting factor, and the resulting products are summed to result in a source quality metric. Source Quality 3020 then provides this source quality metric to Ranker 3080.

The submetrics retrieved by Source Quality 3020 comprise any combination of page quality, domain quality, source bias, source accuracy and peer review submetrics. The page quality submetric is a measure of the general quality of the data received from a particular node. The domain quality submetric is a measure of the general quality of data received from the node's network domain (e.g., the fedstats.gov or the yahoo.com network domain). The source bias submetric is a measure of the bias, i.e., the non-objectiveness, of a particular data source (e.g., a rule might be applied that states that a political action committee has a high bias). The source accuracy submetric is a measure of the accuracy of a particular data source (e.g., the National Institute of Standards might be evaluated to have a high degree of accuracy). The peer review submetric is based upon the extent to which a particular data source has been subject to peer review (e.g., an article in the New England Journal of Medicine might be evaluated to have a high degree of peer review).

### User Evaluation 3030

An Administrator 3001, one or more Expert Users 3002, and one or more ordinary Users 3003 may generate submetrics by subjective evaluation of the quality of various sets of plot data. These submetrics, which are related to the quality of the plot data, are received and stored by the User Evaluation Data Repository 3060. When User Evaluation 3030 receives a particular set of plot data from a network node, it retrieves any available submetrics corresponding to that plot data from the User Evaluation Data Repository 3060. Each of these different submetrics is multiplied by a corresponding weighting factor, and the resulting products are summed to result in a user evaluation quality metric. User Evaluation 3030 provides this user evaluation quality metric to Ranker 3080.

The submetrics determined by User Evaluation 3030 comprise any combination of utility, density, data bias, completeness of metadata, relevance and data accuracy submetrics. The utility submetric is a measure of the usefulness of the plot data to the user. The density and completeness of metadata submetrics are described previously in the discussion regarding Table Quality 3010. The relevance submetric is a measure of the relevance of the plot data to the objectives of the user. The data bias submetric is a measure of the bias, i.e., non-objective quality, of a particular set of plot data. The data accuracy submetric is a measure of the accuracy of a particular set of plot data.

### Usage 3040

The Experience Data Repository 3070 contains usage submetrics related to the past use of node data; these usage submetrics have been stored in the Experience Data Repository 3070 by another system or systems with which the depicted embodiment of the invention interoperates. Usage 3040 retrieves the usage submetrics from the Experience Data Repository 3070. Each of these different submetrics is multiplied by a corresponding weighting factor, and the resulting products are summed to result in a usage quality metric. Usage 3040 provides this usage quality metric to Ranker 3080.

The submetrics retrieved by Usage 3040 comprise any combination of views and uses submetrics. The views submetric is a measure of the number of times that data from a particular node has been viewed by an individual while using the previously specified other system or systems. The uses submetric is a measure of the number of times that data from a particular node has been used, e.g., downloaded or compared to another set of data, by an individual while using the other system or systems. In an alternate embodiment, the calculation of the usage quality metric includes the ratio of views to uses; this accounts, for example, for data that is viewed but never downloaded or compared.

### Ranker 3080

In the depicted embodiment, Ranker 3080 determines a quality score, or rank index, by combining the quality metrics received from Table Quality 3010, Plot Quality 3015, Source Quality 3020, User Evaluation 3030 and Usage 3040. In one embodiment, the rank index is calculated by multiplying each quality metric by a corresponding weighting factor, and then summing the resulting products. The determined rank index is stored by Ranker 3080 in the Rank Index Data Repository 3090. As noted previously, the rank index information stored in the Rank Index Data Repository 3090 may be accessed by other systems, e.g., an Internet crawler application, for which this rank index information would be useful.

It should be noted that while FIG. 1 depicts combining each of the quality metrics to obtain a rank index, the invention is not so limited. In particular, alternative embodiments of the invention permit using various combinations of one or more of these metrics (to include weightings of these metrics) to derive the rank index.

The embodiments of the present invention may be implemented with any combination of hardware and software. If implemented as a computer-implemented apparatus, the present invention is implemented using means for performing all of the steps and functions described above.

The embodiments of the present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of the present invention is not limited to the particular examples and implementations disclosed herein, but is intended to cover modifications within the spirit and scope thereof as defined by the appended claims and any and all equivalents thereof.

I/We claim:

1. A method for creating a quality score for a set of tabular data, said method comprising:
(a) determining one or more quality metrics corresponding to said set of tabular data; and
(b) combining said quality metrics to create a quality score for said set of tabular data.

2. The method of claim 1, wherein each of said one or more quality metrics comprises a value between and including 0 and 1.

3. The method of claim 1, wherein said determining step comprises applying one or more rules to said set of tabular data.

4. The method of claim 1, wherein at least one of said quality metrics is determined by multiplying one or more submetrics by corresponding weighting factors and adding the products of said multiplications.

5. The method of claim 1, wherein said combining step comprises multiplying said quality metrics by corresponding weighting factors and adding the products of said multiplications.

6. The method of claim 1, wherein said set of tabular data includes plot data.

7. The method of claim 1, further comprising:
(c) obtaining said set of tabular data from sources on a computer network.

8. The method of claim 1, further comprising:
(c) obtaining said set of tabular data from a single computer.

9. The method of claim 1, wherein at least one of said quality metrics is a table quality metric.

10. The method of claim 9, wherein said table quality metric is based at least on one or more submetrics, said submetrics selected from the group consisting of density, completeness of metadata, consistency and size.

11. The method of claim 1, wherein at least one of said quality metrics is a source quality metric.

12. The method of claim 11, wherein said set of tabular data has a source, and wherein said source quality metric is based at least on one or more submetrics, said submetrics selected from the group consisting of page quality, domain quality, source bias, source accuracy and peer review.

13. The method of claim 1, wherein at least one of said quality metrics is a user evaluation metric.

14. The method of claim 13, wherein said user evaluation quality metric is based at least on one or more submetrics, said submetrics selected from the group consisting of utility, density, data bias, completeness of metadata, relevance and data accuracy.

15. The method of claim 1, wherein at least one of said quality metrics is a usage metric.

16. The method of claim 15, wherein said usage metric is based at least on one or more submetrics, said submetrics selected from the group consisting of views and uses.

17. An article of manufacture for creating a quality score for a set of tabular data, the article of manufacture comprising a machine-readable medium holding machine-executable instructions for performing a method comprising:
(a) determining one or more quality metrics corresponding to said set of tabular data; and
(b) combining said quality metrics to create a quality score for said set of tabular data.

18. The article of manufacture of claim 17, wherein each of said one or more quality metrics comprises a value between and including 0 and 1.

19. The article of manufacture of claim 17, wherein said determining step of said method comprises applying one or more rules to said set of tabular data.

20. The article of manufacture of claim 17, wherein said determining step of said method comprises multiplying one or more submetrics by corresponding weighting factors and adding the products of said multiplications.

21. The article of manufacture of claim 17, wherein said combining step of said method comprises multiplying said quality metrics by corresponding weighting factors and adding the products of said multiplications.

22. A system for creating a quality score for a set of tabular data, said system comprising:
(a) an input interface for receiving said set of tabular data;
(b) a processor for determining one or more quality metrics corresponding to said set of tabular data and combining said quality metrics to create a quality score for said set of tabular data; and
(c) a storage device for storing said quality score.

23. The system of claim 22, wherein each of said one or more quality metrics comprises a value between and including 0 and 1.

24. The system of claim 22, wherein said determining one or more quality metrics comprises applying one or more rules to said set of tabular data.

25. The system of claim 22, wherein said determining one or more quality metrics comprises multiplying one or more submetrics by corresponding weighting factors and adding the products of said multiplications.

26. The system of claim 22, wherein said combining said quality metrics comprises multiplying said quality metrics by corresponding weighting factors and adding the products of said multiplications.
